(19) United States
(12) Patent Application Publication
(10) Pub. No.: US 2004/0164874 A1
(43) Pub. Date: Aug. 26, 2004

(54) Waveform learning apparatus of remote controller

(76) Inventors: Ching-Hung Tsai, Hsinchu (TW); Tom Huang, Hong Kong (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 10/373,089

(22) Filed: Feb. 26, 2003

(51) Int. Cl. H04L 17/02

(52) U.S. Cl. 340/825.72; 341/176

(57) ABSTRACT

The present invention generally relates to disclose a waveform learning apparatus of remote controller. The waveform learning apparatus of remote controller includes a signal-receiving interface for receiving the household appliance remote controller signal. The signal-receiving interface connects to a microprocessor. The present invention utilizes the high operation ability of the microprocessor to perform the process of waveform digitizing on the received signal and then to store the waveform digitized data in a memory unit. Following, the present invention utilizes the signal-transmitting interface to transfer the remote signal to achieve the purpose of controlling the household appliance. The present invention can completely copy the signal of multiple remote controllers to replace the original remote controller, so the present invention provides with the advantages of easily learning, quick and precise.

### BACKGROUND OF THE INVENTION

1. Field of the Invention

The present invention generally relates to an application to the waveform learning apparatus of the remote controller, and more particularly relates to a waveform learning apparatus for simultaneously a plurality of infrared ray remote controllers so as the present invention can replace actions of all kinds of the remote controllers.

2. Description of the Prior Art

With the development of the technology industry, more and more household appliances are adopting the remote controller to control for the consideration of the convenience at the household appliances on the current market condition, such as the television, the videocassette recorder, the air conditioning, the audio, and etc. However, most of the remote controllers use the infrared remote sensing to transmit the remote code and single remote controller can only control one of the household appliances. Hence, it is a burden for the user having so many remote controllers not only because of the easily loss but also because of the inconvenient using.

In order to let the user use and manage these remote controllers more convenient, some businessman design a universal remote controller provided with the learning function so as to assembling multiple remote controllers into single remote controller after learning to replace each remote controller of each household appliances. Hence, the universal remote controller is used to control all of the household appliances. However, the common household appliances uses the infrared remote sensing to transmit the remote code and each remote controller of each household appliance has the totally different carrier wave frequency and control code format of the infrared control code for different brand and different type of the appliances. Hence, as this type universal remote controller adopting the identifying method of the infrared control code for learning, it needs to unceasingly and repeating identifying and testing until identifying the corresponding responded infrared control code and then to start performing the learning process. So, it not only provides the disadvantage of complex learning process but also has the control effect without the expect effect after learning.

Obviously, the main spirit of the present invention is to provide a waveform learning apparatus of a remote controller, which utilizes the waveform learning method to perform the learning process, and then some disadvantages of prior art are overcome.

### SUMMARY OF THE INVENTION

The primary object of the present invention is to provide a waveform learning apparatus of a remote controller. The present invention utilizes the waveform learning technology to achieve completely learning multiple sets of the control signal of remote controllers and simultaneously achieves the effect of one hundred percent completely control.

Another object of the present invention is to provide a waveform learning apparatus of a remote controller. The present invention provides with the advantage of easily and quickly learning process to provide the user easily set all remote controller of the household appliance simplifying learning into the same remote controller to achieve the purpose of the waveform learning apparatus for assembling multiple remote controllers into one remote controller.

A further object of the present invention is to provide a quickly and precisely waveform learning apparatus of a remote controller to replace the original remote controllers to solve the disadvantage of the prior art.

In order to achieve previous objects, a waveform learning apparatus of a remote controller of the present invention includes a signal-receiving interface for receiving more than one of the household appliance remote controller signals; a microprocessor connecting with the signal-receiving interface and receiving the transmitted remote controller signal, wherein the microprocessor converts the remote controller signal into a waveform digitized data; a memory unit for storing the processed waveform digitized data by the microprocessor; a keyboard interface for selecting the waveform digitized data within the memory unit; and a signal-transmitting interface to transmit a remote signal corresponding to the waveform digitized data selected from the keyboard interface so as to achieve the purpose of controlling the household appliance.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic representation of the architecture block chart, in accordance with the present invention; and

FIG. 2 is a schematic representation of the architecture block chart, in accordance with one embodiment of the present invention.

### DESCRIPTION OF THE PREFERRED EMBODIMENT

The present invention utilizes the waveform learning method to completely learning multiple sets of different household appliance remote control signal for providing the user easily set all remote controller of the household appliance simplifying learning into the same remote controller to achieve the purpose of the waveform learning apparatus for assembling multiple remote controllers into one remote controller.

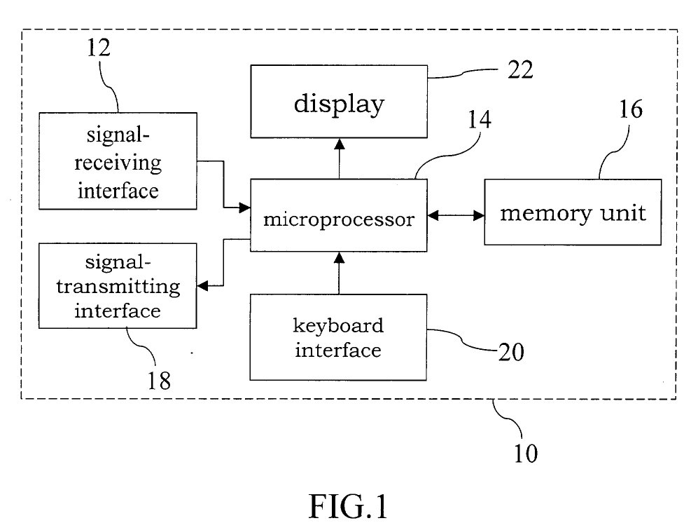

Referring to the FIG. 1, it is a schematic representation of the architecture block chart in accordance with one preferred embodiment of the present invention. Such as shown in the FIG. 1, a waveform learning apparatus of remote controller 10 is including a signal-receiving interface 12, which is usually an electronics circuits for receiving the required learned household appliance remote controller signal and for providing the learning channel. A microprocessor 14 connects to the signal-receiving interface 12. The microprocessor 14 receives the household appliance remote controller signal received from the signal-receiving interface 12 and converts the remote controller signal into a waveform digitized data. That is to utilize the high operation ability of the microprocessor 14 to perform the waveform digitizing process of the signal received from the signal-receiving interface 12 so as to make the household appliance remote controller signal waveform digitized. Furthermore, the microprocessor 14 connects a memory unit 16, a signal-transmitting interface 18, a keyboard interface 20, and a display 22 simultaneously so as to utilizing the memory unit 16 to store the waveform digitized data processed by the microprocessor 14. Wherein, the stored waveform digitized data within the memory unit 16 is compressed data, so it can save the storage space of the memory.

The memory unit 16 uses to store the waveform digitized data processed by the microprocessor 14. The keyboard interface 20 uses to select the waveform digitized data within the memory unit 16. The signal-transmitting interface 18 uses to output the waveform data, which is the remote signal for control the action of the household appliances, corresponding to the waveform digitized data selected from the keyboard interface 20. The display 22 is a light emitting diodes (LED) indicator light, which uses for displaying the input/output status of the waveform data.

Wherein, the memory unit 16 mentioned above can be selected from the group of the read-only memory (ROM), the random access memory (RAM), the flash memory, the electrically programmable erasable read-only memory (EEPROM), and so on.

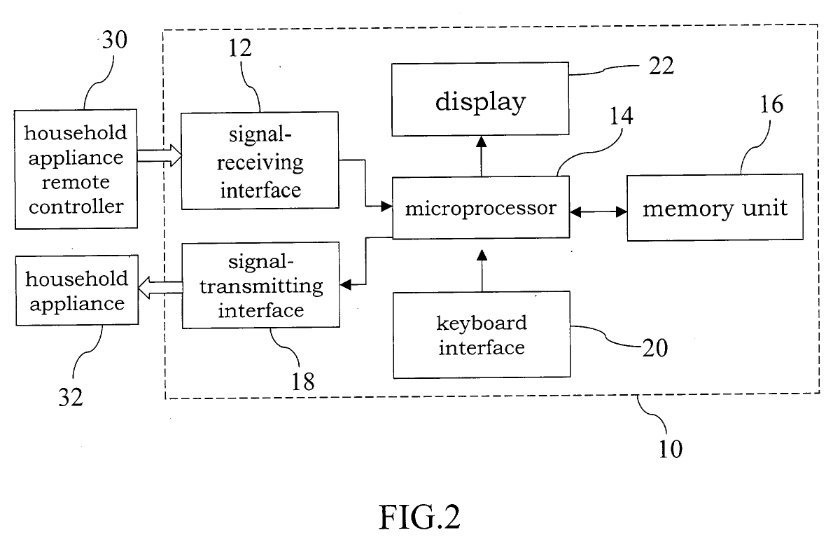

Referring to the FIG. 2, the input/output control before and after learning the household appliance remote controller of the present invention is as shown in the FIG. 2. First, the present invention uses the signal-receiving interface 12 to read in the signal of household appliance remote controller 30 required learning and to store the signal, which is waveform digitized by the microprocessor 14, in the memory unit 16. Wherein, while the microprocessor 14 receiving the signal of the household appliance remote controller 30 via the signal-receiving interface 12, the invention utilizes each key of the household appliance remote controller 30 as an unit to one by one learn and copy, and to store the compressed waveform digitized data processed by the microprocessor 14 into the memory unit 16. Then, after the user utilizes the keyboard interface 20 selecting, the microprocessor 14 will transfer the waveform data within the memory unit 16 to the signal-transmitting interface 18 to output and the display 22 is an output indicator to achieve the purpose of controlling the household appliance 32.

The present invention provides a quickly and precisely waveform learning apparatus of a remote controller, wherein the waveform learning apparatus is to utilize the waveform learning technology to achieve completely learning multiple control signal of remote controllers to replace the original remote controller and simultaneously achieves the effect of one hundred percent completely control. Furthermore, the present invention provides with the advantage of easily and quickly learning process to provide the user easily put all remote controller of the household appliance simplifying learning into the same remote controller to achieve the purpose of the waveform learning apparatus for assembling multiple remote controllers into the same remote controller (the waveform learning apparatus of the remote controller) so as to solve the disadvantage of the prior art of the universal remote controller.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A waveform learning apparatus of a remote controller, wherein said waveform learning apparatus can learn more than one set of a household appliance remote controller signal, said waveform learning apparatus of said remote controller including:
a signal-receiving interface, wherein said signal-receiving interface receives said household appliance remote controller signal;
a microprocessor connecting with said signal-receiving interface and receiving said transmitted remote controller signal, wherein said microprocessor converts said remote controller signal into a waveform digitized data;
a memory unit for storing said waveform digitized data processed by said microprocessor;
a keyboard interface for selecting said waveform digitized data within said memory unit; and
a signal-transmitting interface to transmit a remote signal corresponding to said waveform digitized data selected from said keyboard interface.

2. The waveform learning apparatus of the remote controller according to claim 1, further comprises a display connecting to said microprocessor for displaying the input/output status performing via said signal-receiving interface and said signal-transmitting interface.

3. The waveform learning apparatus of the remote controller according to claim 2, wherein said display is a light emitting diodes (LED) indicator light.

4. The waveform learning apparatus of the remote controller according to claim 1, wherein said memory unit can be selected from the group of the read-only memory (ROM), the random access memory (RAM), and the electrically programmable erasable read-only memory (EEPROM).

5. The waveform learning apparatus of the remote controller according to claim 1, wherein while said microprocessor receiving said household appliance remote controller signal via said signal-receiving interface, each keyboard of said household appliance remote controller is used as an unit to learn and copy one by one to store in said memory unit after processed via said microprocessor.
